(19) United States
(12) Patent Application Publication
(10) Pub. No.: US 2009/0020994 A1
(43) Pub. Date: Jan. 22, 2009

(54) ROLLOVER SYSTEM FOR MOTOR VEHICLES WITH AT LEAST ONE PYROTECHNICALLY ERECTABLE ROLLOVER BODY

(75) Inventor: Frank Liesaus, Bergneustadt (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: ISE AUTOMOTIVE GMBH, Bergneustadt (DE)

(21) Appl. No.: 12/143,908

(22) Filed: Jun. 23, 2008

(30) Foreign Application Priority Data
Jun. 21, 2007 (DE) 10 2007 029 097.9

(51) Int. Cl. B60R 21/13

(52) U.S. Cl. 280/756

(57) ABSTRACT

A rollover protection system is provided for motor vehicles having at least one actively deployable rollover body (2), which in the normal operating state is kept in a rest position and which is deployable into a support position by a pyrotechnic actuator (6). In order to provide a rollover protection system, in which the pyrotechnic actuator (6) has a space saving, highly efficient, and economical arrangement, the protection system provides, among other things, that the rollover body (2) is deployable by the actuator (6) according to the principle of a rocket propulsion system.

### CROSS-REFERENCE TO RELATED APPLICATIONS

This application claims priority to German Patent Application No. 10 2007 029 097.9 filed Jun. 21, 2007. The contents of German Patent Application No. 10 2007 029 097.9 are hereby incorporated by reference into the present application in their entirety.

### BACKGROUND OF THE INVENTION

The invention relates to a rollover protection system for motor vehicles.

Such rollover protection systems are used for protecting the occupants in motor vehicles without a protective roof, typically in convertibles or roadsters, during a rollover accident, because the vehicle will roll off the deployed rollover body, which provides the occupants with a survival space.

Here, it is known to provide a roll bar constructed as part of the car body and spanning the entire vehicle width. With this solution, the increased wind resistance and the generation of driving noise is perceived as disadvantageous, apart from the negative effect on the vehicle appearance.

It is also known to allocate for each vehicle seat a height-invariable roll bar, which is installed fixed in the passenger compartment, i.e., which is rigid and has a U-shaped form. This solution is typically used in roadsters for emphasizing the sporty appearance.

Very common in convertibles are structural solutions, in which the rollover body is retracted in the normal state and, in the case of danger, that is, for an imminent rollover accident, the rollover body is very quickly deployed into a protective position, in order to prevent the vehicle occupants from being crushed by the rolling vehicle.

These so-called “active” rollover protection systems typically have a U-shaped roll bar guided in a guide body fixed to the vehicle or a rollover body formed from a profiled body, wherein the guide body is mounted in a cassette housing, which has side parts and a base part. In the normal state, this roll bar or rollover body is held by a holding device in a position, a rest position, against the biasing force of at least one drive pressure spring and, in the case of a rollover accident, can be brought into an upper, protective position under the control of a sensor by releasing the holding device through the spring force of the drive pressure spring, wherein a locking device, a retraction block, which engages with teeth, prevents the roll bar from being pressed back. Here, typically a cassette is allocated to each vehicle seat. Such a cassette construction of an active rollover protection system having a U-shaped roll bar is shown, for example, in German Patent DE 100 40 649 C1.

In addition, rollover protection systems are known having a roll bar, which can be deployed actively and which spans approximately the entire vehicle width.

Both the seat-specific cassette constructions and also the roll bar spanning approximately the entire vehicle width have been brought to the market and are in operation in many embodiments adapted to each vehicle model. Here, vehicles are also known, in which a roll bar can be pivoted up into a vertical protective position from a horizontal rest position.

In all of these different constructions for rollover protection, which can also be formed by use of the invention, it is necessary to provide a holding device that can be released in the case of danger for the rollover body fixed in a rest position and a drive for the deployment or pivoting of each rollover body after the holding device is released.

Typical releasable holding devices comprise, for example, a holding member mounted on the rollover body and a release mechanism, typically a ratchet mechanism, on a sensor-controlled actuator, which can be formed by a so-called electrically activated release magnet or alternatively by a pyrotechnic element according to German published patent application No. DE 43 42 401 A1. Such a pyrotechnic element typically has a pyrotechnic propellant (charge), which is installed in a housing of a cylinder-piston unit, wherein, when the pyrotechnic propellant is ignited, a small piston rod (which retracts or ejects a pin) activates the release mechanism and thus cancels the holding of the fixed rollover body. FIG. 2 shows an example of how the top part of a roll bar can be driven directly by a gas generator. Here, the piston defines an essentially cylindrical expansion chamber, on which a gas generator is mounted. When the pyrotechnic priming charge is ignited by an electric voltage in the gas generator fixed to the vehicle, the generated gas builds up a pneumatic pressure, which displaces the piston, in the expansion chamber. The roll bar is extended in this way. In addition to the direct drive of a roll bar described in FIG. 2, an indirect drive by the pressure generated by the gas generator is also possible. In each case, the gas generator is fixed to the vehicle.

From German Patent DE 199 06 912 C1, it is known to form a drive arrangement for the steady, slow movement of the rollover body with the headrest, wherein this drive arrangement has no effect on the quick drive in the case of a rollover accident. For this purpose, an actuator, which can be an electromagnetic or a pyrotechnic actuator, is mounted on a movable traverse. The actuator is set by means of a drive spindle by a drive mounted rigidly on the vehicle for activating the headrest adjustment, which is part of the rollover body. In the case of danger, that is, for the quick drive, the traverse with the actuator located thereon becomes separated, so that the actuator remains fixed to the vehicle.

German Patent DE 954 021 B discloses a device for the automatic regulation of a reaction propulsion system, preferably a rocket, wherein the thrust is controlled by the quantity of reactant. This involves a known propulsion system from the field of aviation.

From German Patent DE 199 60 764 B4, it is known to provide a common pyrotechnic gas generator fixed to the car body for releasing the holding device and for ejecting the moving element. Here, the holding device is made from a locking pin with an undercut flange, which is connected to the moving element, and a locking collar fixed to the car body with a moving locking hook for the releasable engagement with the undercut section on the locking pin. When the gas generator fixed to the car body is triggered, first, as described above, the holder is released by the gas pressure and then the separate telescoping arrangement of the cylinder tube fixed to the car body on the installation frame with the piston rod mounted on the extendable roll bar by means of a drive crossbar ensures that the roll bar can extend. The pressure gas here flows via the overflow boreholes into the space between the drive piston and the retaining ring and here applies pressure on the drive piston.

With an increasing number of components for the production of the holding device, the risk for defective functioning also increases. This results, among other things, from an addition of different tolerances. Furthermore, the entire holding and deployment unit involves an additional and thus expensive embodiment; due to the cost pressure in the automotive supplier industry, however, the call for more economical systems is louder and louder.

### BRIEF SUMMARY OF THE INVENTION

An object of the invention is to provide a reliable and economical rollover protection system, which can be integrated into a vehicle in a space-saving way.

Characteristic of the rollover protection system according to the invention is that the pyrotechnic actuator is mounted on the deployable part of the rollover protection system in a pressure chamber of the rollover body, wherein the pyrotechnic actuator is a gas generator. Within the scope of the invention, the rollover body always involves the extendable part of the rollover protection system.

The rollover protection system according to the invention allows a very compact construction of the entire rollover protection system. Additional components, such as drive pistons, piston rods, cylinder tubes, deployment springs, and the like, which are required in rollover protection systems known from the prior art, can be completely eliminated. Thus, the rollover protection system according to the invention distinguishes itself by its economical, insusceptible, reliable, and highly efficient construction, which, as described above, results, in particular, from the small number of required components.

The pyrotechnic actuator is located in a sort of “pressure chamber” of the rollover body. The pressure chamber is already present due to the predetermined shape of the rollover body in nearly all of the embodiments of the rollover protection systems introduced on the market. This relates both to U-shaped rollover bodies, which are formed from tubes, and also rollover bodies assembled with a shell construction, such as from German Patent DE 10 2005 004 646 B3, and also the cassette-shaped rollover bodies formed from profiled bodies.

Just for reasons of weight, material, and technical costs, all of these variants involve hollow bodies. Advantageously, the invention uses the provided hollow spaces without requiring additional components.

The pressure space can be reduced in size selectively by a bulkhead element placed above the pyrotechnic actuator, in order to be able to use also pyrotechnic actuators with small charges. In this case, the pyrotechnic actuator is installed in the pressure space in such a way that there is sufficient space around the pyrotechnic actuator, so that the pressure gases can escape around the actuator and thus the corresponding thrust force is generated.

Advantageously, the connection between the pulse-generating sensor unit and the pyrotechnic actuator is formed by contacts in the base position of the rollover body, so that an electrical supply line to the pyrotechnic actuator is not severed during the upward movement.

According to one embodiment of the invention, the pyrotechnic actuator can be changed out after its ignition, without requiring new wiring of the pyrotechnic actuator. The pyrotechnic actuators or gas generators produce a very large quantity of energy outward from the housing, so that there is no problem filling the different hollow spaces with their different volumes with pressure gas. In principle, the deployment of the rollover body functions like a “rocket propulsion system.”

In one embodiment, the holder of the rollover body is also released by the pyrotechnic actuator after its “ignition.” The holder can be formed here by a destructible “bursting element.” The bursting element involves a connection element between the part of the rollover protection system fixed to the vehicle and the extendable part of the rollover protection system, the rollover body. Thus, the bursting element can have a defined rupture point, which is destroyed when the pyrotechnic actuator is ignited. By the described holding by a bursting element, the rollover body is held in its retracted position, the rest position. Thus, rattling noises due to unevenness of the driving surface and unintended pulling out of the rollover body are similarly prevented.

Instead of a bursting element, the holder can also be formed by a conventional latch arrangement. The emerging gas pressure then first opens the latch before the remaining gas pressure deploys the rollover body. Advantageously, such a latch arrangement involves a sort of “rocker.” This rocker has two arms, wherein one arm with an appropriate deformation ensures that the rollover body is held and the other arm receives the pressure of the propellant gas and thus releases the holder. Advantageously, this second arm has a large surface area, in order to absorb the pressure gases correspondingly efficiently. The second arm can sit directly under the pressure chamber of the rollover body and the first arm can sit next to the pressure chamber. Thus, the pressure of the propellant gases advantageously impinges only on the second lever arm.

However, other positive-fit and/or non-positive connections could also be provided as the holder, such as caulking, edge crimping, press fit, etc. Material-fit connections that can be released by the pressure of the propellant gases are also conceivable.

An alternative structure provides an additional pressure chamber element, which lies at least partially inside the rollover body or which can at least partially surround this body. The additional pressure chamber element is then mounted stationary on the vehicle-fixed part of the rollover protection system. Advantageously, smaller pyrotechnic charges can be used with this alternative structure.

The rollover protection system can have many different constructions, e.g., a tubular construction for the extendable part of the rollover protection system. That is, the actual rollover body can be considered as well as a cassette system formed by profiles.

The materials that are used can also be very varied. Thus, e.g., steel, plastic, in particular fiber-reinforced plastic, magnesium and aluminum can be used. Here, a combination of the different materials is obviously also conceivable.

The rollover protection system according to the invention distinguishes itself, among other things, by its compact construction. An additional space savings can be achieved according to one embodiment of the invention, in that the frame leg or even the profiled body of the rollover body lies in the direct vicinity of the base of the rollover protection system or, if this is omitted for spatial reasons, in the direct vicinity of the car structure, which is located under the rollover body. Consequently, no significant installation space is lost, which could be used for the deployment stroke and which could increase the survival space for the occupants. The deployment stroke is given by the difference between the retracted rollover body and the extended rollover body. The farther the rollover body can extend, the larger the rollover tangent will also be. This is measured by a tangent lying above the roof-side windshield frame toward the extended rollover bodies. The more space formed underneath this tangent for the occupants, the greater the safety for the vehicle occupants in case of a rollover accident. The embodiment improves the protection for the vehicle occupants in a complementary way.

The pyrotechnic actuator can be fixed on the rollover body with a wide variety of different attachment methods. Possibilities include non-positive fit, positive fit, and also material fit connections. Examples only to be named here are screws, rivets, catch connections, and adhesive bonds.

In a complementary way, the space-saving accommodation of the pyrotechnic actuator provides space around the periphery, so that space is created for charge possibilities or other components.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic, partially broken away, isometric view of a rollover protection system according to an embodiment of the invention, in a rest position, which has a pyrotechnic actuator in the rollover body;

FIG. 2 is a view similar to FIG. 1 showing an embodiment of the invention, but in the deployed state of the rollover body;

FIG. 3 is a schematic partial cutout view of a rollover protection system according to FIG. 1, illustrating the position of the pyrotechnic actuator according to the invention; and

FIG. 4 is schematic, perspective view, partially broken away, of a variant of the rollover protection system according to FIG. 2, with a pressure chamber element.

Information such as left, right, or top and bottom refer to the illustrated view.

### DETAILED DESCRIPTION OF THE INVENTION

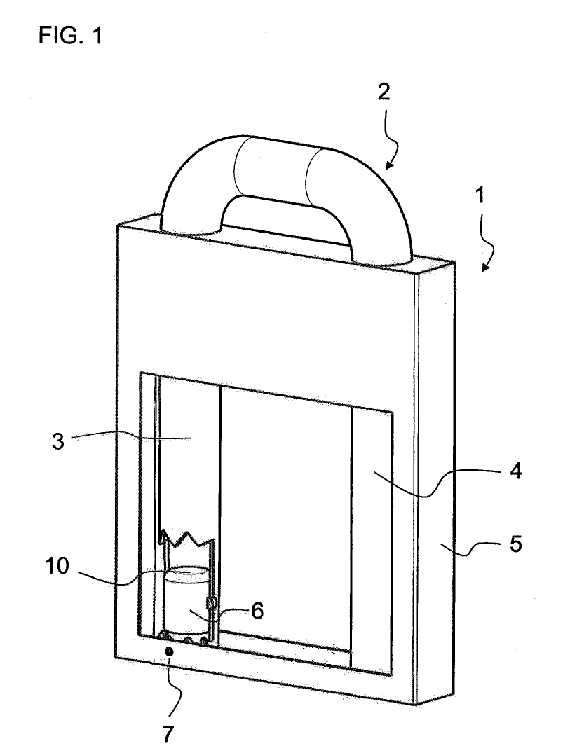

A rollover protection system 1 illustrated in FIG. 1 has a rollover body 2, which is formed essentially of two frame legs 3, 4 connected on the top side by a sort of crossbar and which is shown in a rest position. In the left frame leg 3, shown in a broken away illustration, the arrangement of a pyrotechnic actuator 6 can be seen.

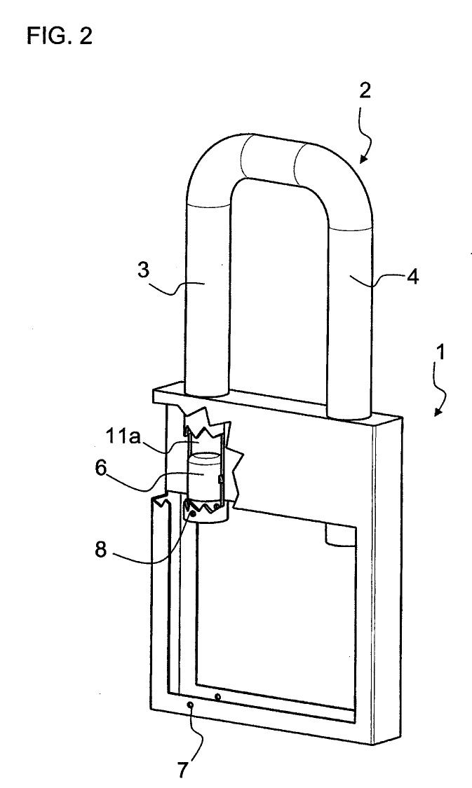

In the rest position of the rollover body 2 shown in FIG. 1, this body is located in a cassette-like housing 5 fixed to the vehicle. The holder is formed by a not-shown bursting element, which secures the position of the rollover body 2 in the rest position and which prevents the rollover body 2 from being pulled out or which provides security against undesired rattling. The bursting element is the holding member between the part of the rollover protection system 1 fixed to the vehicle and the extendable rollover body 2. It is located, for one, in opposing holes 7 of a lower traverse of the housing 5 and, for another, in opposing holes 8 on the end of the left frame leg 3 (see FIG. 2).

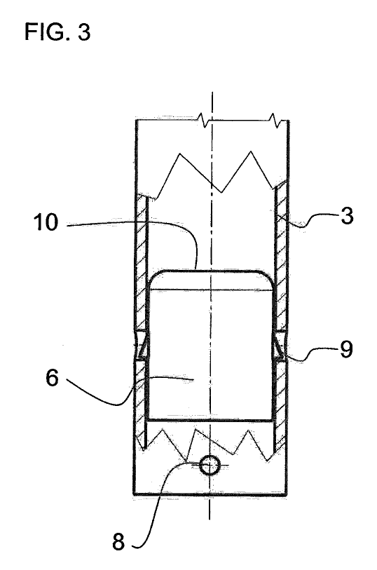

In this embodiment, the pyrotechnic actuator 6 sits in the lower end of the left frame leg 3. By two catch elements 9 (see FIG. 3), which are components of the pyrotechnic actuator 6, this is held in the predetermined position in the rollover body 2, in this case the left frame leg 3. The catch elements 9 lock in holes of the left frame leg 3, which are allocated to this leg. If the pyrotechnic actuator 6 is ignited, the pressure gases escape at the upper end of the pyrotechnic generator 10. They fill up the rollover body 2, i.e., they are conducted through the left frame leg 3 and via the crossbar into the right frame leg 4. The pressure force is so great that first the bursting element is destroyed at its desired rupture point. The remaining pressure gases ensure that the rollover body is deployed like a “rocket.” In the extended position, the rollover body 2 locks.

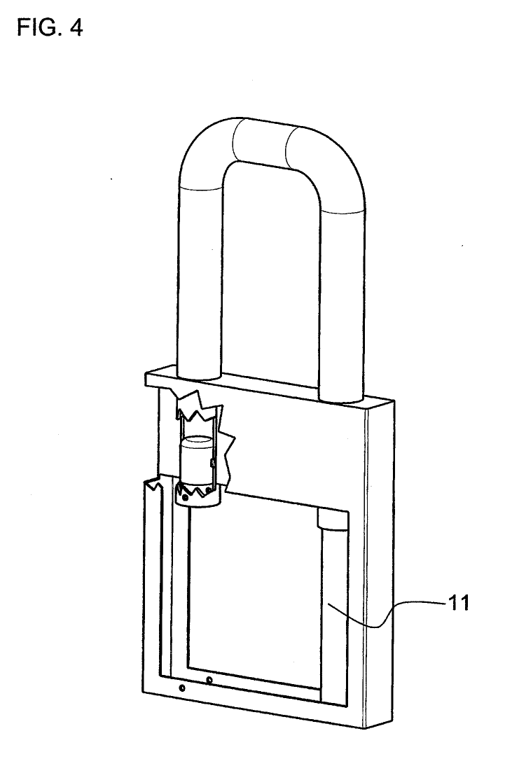

In the embodiment according to FIG. 4, an additional pressure chamber 11 is provided in active connection with the pyrotechnic actuator 6 and fixed to the vehicle in such a way that the pressure chamber takes up pressure gases generated by the actuator.

The components necessary for the function of the active rollover protection system 1, such as the guide and the locking unit for the deployed rollover body 2, are not shown, but have been known for a long time from relevant patent publications, especially those of the applicant.

In an embodiment not shown here, the bursting element has, in addition to a desired rupture point on one end, a head and, in the region of the other end, is fixed in position by securing means, such as a retaining plate. Thus, the bursting element has a secure position for all operating states.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-12. (canceled)

13. A rollover protection system for a motor vehicle, the system comprising at least one actively deployable rollover body (2), which in a normal operating state is kept in a rest position and is deployable into a support position by a pyrotechnic actuator (6), wherein the pyrotechnic actuator (6) is fixed on the deployable rollover body (2) in a pressure chamber (11a) of the rollover body (2), and wherein the pyrotechnic actuator (6) is a gas generator.

14. The rollover protection system according to claim 13, wherein the pyrotechnic actuator (6) is fixed in a frame leg (3, 4) of the rollover body (2).

15. The rollover protection system according to claim 13, wherein the pyrotechnic actuator (6) is arranged in such a way that free space is formed around it for circulating pressure gases generated by the actuator.

16. The rollover protection system according to claim 13, wherein the pyrotechnic actuator (6) in the rest position of the rollover body (2) is connected by contacts with a pulse-generating sensor unit.

17. The rollover protection system according to claim 13, wherein the pyrotechnic actuator (6) is constructed as an exchangeable unit.

18. The rollover protection system according to claim 13, wherein the pyrotechnic actuator (6) is in active connection with a bursting element, which releases a holder for the rollover body.

19. The rollover protection system according to claim 18, wherein the pyrotechnic actuator (6) is in active connection with at least one latch, which releases the holder.

20. The rollover protection system according to claim 13, wherein the pyrotechnic actuator (6) is in active connection with at least one other pressure chamber element (11), which is fixed on the vehicle in such a way that the pressure chamber element takes up pressure gases.

21. The rollover protection system according to claim 13, wherein a bulkhead element is located in a use position above the pyrotechnic actuator (6).

22. The rollover protection system according to claim 13, wherein the rollover body (2) is formed by at least one of a tube, a profiled body or two shell components.

23. The rollover protection system according to claim 13, wherein the rollover body (2) is located in a direct vicinity of a base of the rollover protection system.

24. A vehicle having a rollover protection system according to claim 13, wherein the rollover body (2) is located in a direct vicinity of a vehicle structure, which lies underneath the rollover protection system.
